(19) United States
(12) Patent Application Publication
(10) Pub. No.: US 2012/0150559 A1
(43) Pub. Date: Jun. 14, 2012

(54) Apparatus, system, and method for processing patient and staff information

(76) Inventors: Armin Wellhõfer, Schwaig (DE); Christof Donitzky, Eckental/Eschenau (DE)

(21) Appl. No.: 12/965,283

(22) Filed: Dec. 10, 2010

(51) Int. Cl. G06Q 50/00; G06F 7/04

(52) U.S. Cl. 705/3; 705/2; 340/5.61; 345/163

(57) ABSTRACT

An interface device, such as a computer mouse, is provided and includes a radio-frequency identification transceiver configured to obtain patient information from a patient radio-frequency identification tag. The computer mouse further includes a microprocessor configured to process the obtained patient information and an interface configured to transfer the obtained patient information to a computer. The patient information includes at least diagnostic data generated by a diagnostic apparatus or treatment information generated by a treatment device and patient identification information.

### TECHNICAL FIELD

The present invention generally relates to RFID tags and readers. In particular, the invention relates to a patient information system utilizing RFID tags.

### BACKGROUND

Patients admitted in a hospital typically undergo several diagnostic procedures using different equipment, which may be located in different rooms. Recording the data associated with the equipment and the patient is burdensome and prone to error.

Further, many doctors, nurses, and technicians need to access and use medical equipment while performing diagnostic procedures, but is desirable that un-authorized users are locked out from the equipment.

### SUMMARY

Accordingly, there is a need for an apparatus, system, or method for processing patient and staff information.

An interface device, such as, for example, a computer mouse, according to one aspect of the invention includes a radio-frequency identification transceiver configured to obtain patient information from a patient radio-frequency identification tag. The computer mouse further includes a microprocessor configured to process the obtained patient information and an interface configured to transfer the obtained patient information to a computer. The patient information includes at least diagnostic data generated by a diagnostic apparatus or treatment information generated by a treatment device, and patient identification information.

The computer mouse may also include a radio-frequency identification transceiver configured to obtain staff information from a staff radio-frequency identification tag. The computer mouse further includes a microprocessor configured to process the obtained staff information and an interface configured to transfer the obtained staff information to a diagnostic apparatus or a treatment device. The staff information includes at least default settings for the diagnostic device or the treatment device or security access information for the diagnostic device or the treatment device.

In some embodiments, the interface device may, instead of a computer mouse, be a piece of furniture of, such as a desk or chair, within, for example, a medical facility.

According to a system aspect of the invention, a patient information processing system includes an interface device, such as, for example, a computer mouse. The computer mouse includes a radio-frequency identification transceiver configured to obtain patient information from a patient radio-frequency identification tag. The computer mouse further includes a microprocessor configured to process the obtained patient information and an interface configured to transfer the obtained patient information to a computer. The system further includes the patient radio-frequency identification tag configured to store the patient information. The patient information includes at least diagnostic data generated by a diagnostic apparatus or treatment information generated by a treatment device and patient identification information. The system further includes at least the diagnostic apparatus or the treatment device.

In some embodiments, the interface device may, instead of a computer mouse, be a piece of furniture, such as a desk or chair, within, for example, a medical facility.

According to another system aspect of the invention, a staff information processing system includes an interface device, such as, for example, a computer mouse. The computer mouse includes a radio-frequency identification transceiver configured to obtain staff information from a staff radio-frequency identification tag. The computer mouse further includes a microprocessor configured to process the obtained staff information and an interface configured to transfer the obtained staff information to a diagnostic apparatus or a treatment device. The system further includes the staff radio-frequency identification tag configured to store the staff information. The staff information includes at least default settings for the diagnostic device or the treatment device or security access information for the diagnostic device or the treatment device. The system further includes at least the diagnostic apparatus or the treatment device.

In some embodiments, the interface device may, instead of a computer mouse, be a piece of furniture, such as a desk or chair, within, for example, a medical facility.

According to a method aspect, a method for processing patient information includes storing patient information on a patient radio-frequency identification tag, wherein the patient information comprises at least diagnostic data generated by a diagnostic apparatus or treatment information generated by a treatment device and patient identification information. The method further includes obtaining the patient information by a radio-frequency identification transceiver of an interface device, such as, for example, a computer mouse, and processing the obtained patient information by a microprocessor of the computer mouse. The method further includes transferring the obtained patient information to a computer by an interface of the computer mouse.

In some embodiments, the interface device may, instead of a computer mouse, be a piece of furniture, such as a desk or chair, within, for example, a medical facility.

According to another method aspect, the method includes storing staff information on a staff radio-frequency identification tag. The staff information comprises at least default settings for a diagnostic device or a treatment device or security access information for the diagnostic device or the treatment device. The method further includes obtaining the staff information by a radio-frequency identification transceiver of an interface device, such as, for example, a computer mouse, and processing the obtained patient information by a microprocessor of the computer mouse. The method further includes transferring the obtained patient information to the diagnostic apparatus or the treatment device by an interface of the computer mouse

In some embodiments, the interface device may, instead of a computer mouse, be a piece of furniture, such as a desk or chair, within, for example, a medical facility.

### BRIEF DESCRIPTION OF THE DRAWINGS

In the following, the invention will be described with reference to exemplary embodiments illustrated in the drawings, wherein

FIG. 1 is a schematic block diagram illustrating an embodiment system including an RFID transceiver integrated into a computer mouse;

FIG. 2 is a flow chart illustrating an embodiment of method for processing patient information; and

FIG. 3 is a flow chart illustrating an embodiment of method for processing staff information.

### DETAILED DESCRIPTION

In the following, for purposes of explanation and not limitation, specific details are set forth, such as particular sequences of steps, components and configurations, in order to provide a thorough understanding of the present invention. It will be apparent to one skilled in the art that the present invention may be practiced in other embodiments that depart from these specific details. For example, the data obtaining and processing functions of computer mouse 104 may be implemented in a piece of furniture of a medical facility (e.g., a dental chair or an observation table).

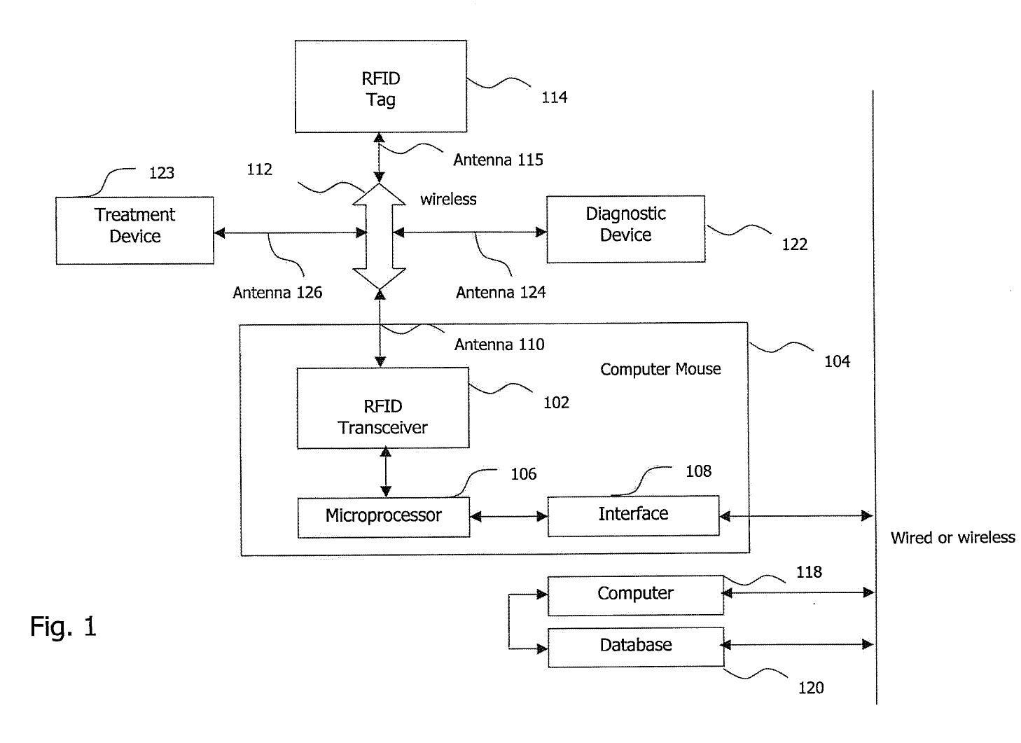

FIG. 1 is a schematic block diagram illustrating an embodiment system 100 of the present invention comprising RFID transceiver 102 integrated into an interface device implemented as computer mouse 104. Computer mouse 104 further includes microprocessor unit 106 and interface 108. RFID transceiver 102 comprises an interrogator or reader (not shown) with antenna 110. Transceiver 102 transmits electromagnetic waves 112 that form a magnetic field that couples with antenna 115 of RFID tag 114. Passive RFID tag 114 draws power from the magnetic field and uses it to power internal circuits to transmit electromagnetic waves 112 to transceiver 102. RFID transceiver 102 converts the received electromagnetic waves 112 into digital data and provides digital data to microprocessor 106. Microprocessor 106 processes data generated by mouse movements and mouse clicks as well as the digital data.

Digital data may include patient information. Patient information may include diagnostic data and/or treatment information generated from a medical device (e.g., weight, blood pressure, dosage), patient identification information, and security access information.

Microprocessor 106 uses interface 108 to communicate data representing the digital data to computer 118 or database 120.

In some embodiments of the present invention, a patient is allocated a bracelet containing, or otherwise housing or connected with, RFID tag 114, wherein the identification data identifying RFID tag 114 may be linked with a patient's name in database 120.

The patient may undergo several diagnostic tests using at least one diagnostic apparatus 122. Diagnostic apparatus 122 may include scales, thermometers, and the like. A patient may also undergo treatment using a treatment device 123. Treatment device 123 may include a radiation device, pill dispenser, and the like. Data generated by diagnostic apparatus 122 or treatment device 123 may be transmitted by respective antennae 124 and 126 to RFID tag 114 via electromagnetic waves 112. The data may be stored in the circuitry of RFID tag 114.

A doctor may then use an interface device, such as computer mouse 104, which interrogates RFID tag 114 via RFID transceiver 102 to retrieve diagnostic data and patient identification information. The received data may then be sent to computer 118 and/or database 120. In alternative embodiments of the invention, the above functions may be implemented using an interface device comprising, for example, an item of furniture of a medical facility. Alternative embodiments of the invention can further include an indicator on the interface device (computer mouse 104 or furniture) that shows where RFID tag 114 should be placed so that it may be interrogated.

In another embodiment, a staff member of the hospital may be issued RFID tag 114. In this case, the circuitry of RFID tag 114 may include default settings for diagnostic device 122, wherein the settings are specific to a staff member. The default settings may be adopted by diagnostic device 122 by reading RFID tag 114. In some embodiments, the circuitry of RFID tag 114 may include security access information that allows the staff member access to use or modify diagnostic apparatus 122 or treatment device 123.

In some embodiments, diagnostic apparatus 122 or treatment device 123 may include markers showing where the staff member or patient should place his or her RFID tag 114 in order to transfer (read and write) data between the RFID tag 114 and the respective device.

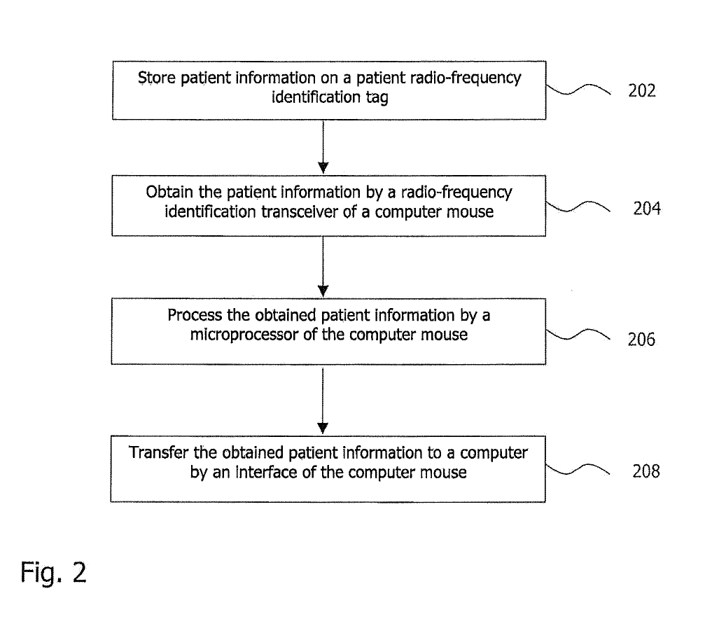

FIG. 2 is a flow chart illustrating an embodiment of a method 200 for processing patient information. At step 202, patient information is stored on a patient radio-frequency identification tag. The patient information includes at least diagnostic data generated by a diagnostic apparatus or treatment information generated by a treatment device, and patient identification information. At step 204, the patient information is obtained by a radio-frequency identification transceiver of an interface device, such as, for example, a computer mouse. At step 206, the obtained patient information is processed by a microprocessor of the computer mouse. At step 208, the obtained patient information is transferred to a computer by an interface of the computer mouse.

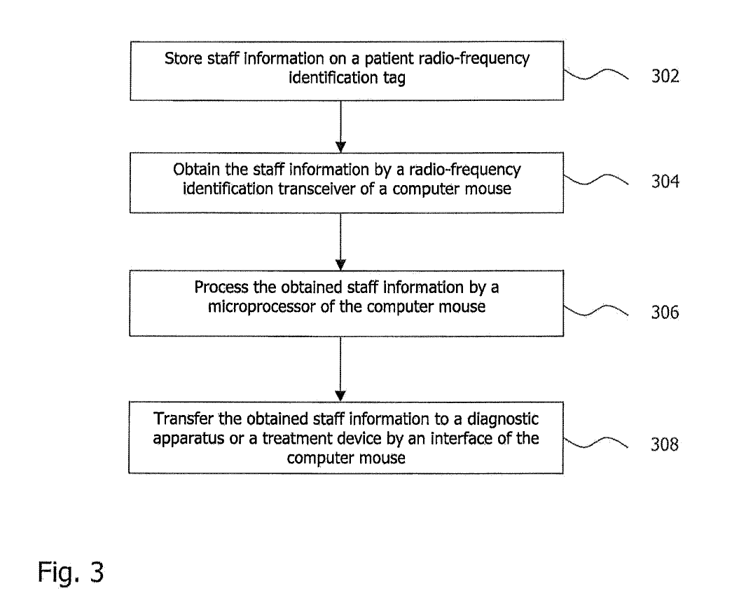

FIG. 3 is a flow chart illustrating an embodiment of method 300 for processing staff information. At step 302, staff information is stored on a staff radio-frequency identification tag. The staff information includes at least default settings for a diagnostic device or a treatment device or security access information for the diagnostic device or the treatment device. At step 304, the staff information is obtained by a radio-frequency identification transceiver of an interface device, such as, for example, a computer mouse. At step 306, the obtained patient information is processed by a microprocessor of the computer mouse. At step 308, the obtained patient information is transferred to the diagnostic apparatus or the treatment device by an interface of the computer mouse.

Although embodiments of the proposed technique have been illustrated in the accompanying drawings and described in the description, it will be understood that the invention is not limited to the embodiments disclosed herein. In particular, the proposed technique is capable of numerous rearrangements, modifications and substitutions without departing from the scope of the invention as set forth and defined by the following claims.

1. A computer mouse, comprising:
a radio-frequency identification transceiver configured to obtain patient information from a patient radio-frequency identification tag;
a microprocessor configured to process the obtained patient information;
an interface configured to transfer the obtained patient information to a computer, wherein the patient information comprises at least:
diagnostic data generated by a diagnostic apparatus or treatment information generated by a treatment device; and
patient identification information.

2. A computer mouse, comprising:
a radio-frequency identification transceiver configured to obtain staff information from a staff radio-frequency identification tag;
a microprocessor configured to process the obtained staff information; and
an interface configured to transfer the obtained staff information to a diagnostic apparatus or a treatment device, wherein the staff information comprises at least:
default settings for the diagnostic device or the treatment device; or
security access information for the diagnostic device or the treatment device.

3. A patient information processing system, comprising
a computer mouse comprising:
a radio-frequency identification transceiver configured to obtain patient information from a patient radio-frequency identification tag;
a microprocessor configured to process the obtained patient information;
an interface configured to transfer the obtained patient information to a computer;
the patient radio-frequency identification tag configured to store the patient information, wherein the patient information comprises at least:
diagnostic data generated by a diagnostic apparatus or treatment information generated by a treatment device; and
patient identification information; and
at least the diagnostic apparatus or the treatment device.

4. A staff information processing system, comprising
a computer mouse comprising:
a radio-frequency identification transceiver configured to obtain staff information from a staff radio-frequency identification tag;
a microprocessor configured to process the obtained staff information; and
an interface configured to transfer the obtained staff information to a diagnostic apparatus or a treatment device;
the staff radio-frequency identification tag configured to store the staff information, wherein the staff information comprises at least:
default settings for the diagnostic device or the treatment device; or
security access information for the diagnostic device or the treatment device; and
at least the diagnostic apparatus or the treatment device.

5. A method for processing patient information, comprising
storing patient information on a patient radio-frequency identification tag, wherein the patient information comprises at least:
diagnostic data generated by a diagnostic apparatus or treatment information generated by a treatment device; and
patient identification information;
obtaining the patient information by a radio-frequency identification transceiver of a computer mouse;
processing the obtained patient information by a microprocessor of the computer mouse; and
transferring the obtained patient information to a computer by an interface of the computer mouse.

6. A method for processing staff information, comprising
storing staff information on a staff radio-frequency identification tag, wherein the staff information comprises at least:
default settings for a diagnostic device or a treatment device; or
security access information for the diagnostic device or the treatment device;
obtaining the staff information by a radio-frequency identification transceiver of a computer mouse
processing the obtained patient information by a microprocessor of the computer mouse; and
transferring the obtained patient information to the diagnostic apparatus or the treatment device by an interface of the computer mouse.

7. A piece of furniture of a medical facility, the piece of furniture comprising:
a radio-frequency identification transceiver configured to obtain patient information from a patient radio-frequency identification tag;
a microprocessor configured to process the obtained patient information;
an interface configured to transfer the obtained patient information to a computer, wherein the patient information comprises at least:
diagnostic data generated by a diagnostic apparatus or treatment information generated by a treatment device; and
patient identification information.

8. A piece of furniture of a medical facility, the piece of furniture comprising:
a radio-frequency identification transceiver configured to obtain staff information from a staff radio-frequency identification tag;
a microprocessor configured to process the obtained staff information; and
an interface configured to transfer the obtained staff information to a diagnostic apparatus or a treatment device, wherein the staff information comprises at least:
default settings for the diagnostic device or the treatment device; or
security access information for the diagnostic device or the treatment device.

9. A patient information processing system, comprising
a piece of furniture of a medical facility, the piece of furniture comprising:
a radio-frequency identification transceiver configured to obtain patient information from a patient radio-frequency identification tag;
a microprocessor configured to process the obtained patient information;
an interface configured to transfer the obtained patient information to a computer;
the patient radio-frequency identification tag configured to store the patient information, wherein the patient information comprises at least:
diagnostic data generated by a diagnostic apparatus or treatment information generated by a treatment device; and
patient identification information; and
at least the diagnostic apparatus or the treatment device.

10. A staff information processing system, comprising
a piece of furniture of a medical facility, the piece of furniture comprising:
a radio-frequency identification transceiver configured to obtain staff information from a staff radio-frequency identification tag;
a microprocessor configured to process the obtained staff information; and
an interface configured to transfer the obtained staff information to a diagnostic apparatus or a treatment device;
the staff radio-frequency identification tag configured to store the staff information, wherein the staff information comprises at least:
default settings for the diagnostic device or the treatment device; or
security access information for the diagnostic device or the treatment device; and
at least the diagnostic apparatus or the treatment device.

11. A method for processing patient information, comprising
storing patient information on a patient radio-frequency identification tag, wherein the patient information comprises at least:
diagnostic data generated by a diagnostic apparatus or treatment information generated by a treatment device; and
patient identification information;
obtaining the patient information by a radio-frequency identification transceiver of a piece of furniture of a medical facility;
processing the obtained patient information by a microprocessor of the piece of furniture; and
transferring the obtained patient information to a computer by an interface of the piece of furniture.

12. A method for processing staff information, comprising
storing staff information on a staff radio-frequency identification tag, wherein the staff information comprises at least:
default settings for a diagnostic device or a treatment device; or
security access information for the diagnostic device or the treatment device;
obtaining the staff information by a radio-frequency identification transceiver of a piece of furniture of a medical facility
processing the obtained patient information by a microprocessor of the piece furniture; and
transferring the obtained patient information to the diagnostic apparatus or the treatment device by an interface of the piece furniture.

13. An interface device, comprising:
a radio-frequency identification transceiver configured to obtain patient information from a patient radio-frequency identification tag;
a microprocessor configured to process the obtained patient information;
an interface configured to transfer the obtained patient information to a computer, wherein the patient information comprises at least:
diagnostic data generated by a diagnostic apparatus or treatment information generated by a treatment device; and
patient identification information.

14. The interface device of claim 13, wherein the interface device comprises a computer mouse.
